(19) United States
(12) Patent Application Publication
(10) Pub. No.: US 2012/0236359 A1
(43) Pub. Date: Sep. 20, 2012

(54) INFORMATION PROCESSING APPARATUS, CONTROL METHOD FOR INFORMATION PROCESSING APPARATUS, AND STORAGE MEDIUM

(75) Inventor: Makoto Mihara, Yokohama-shi (JP)

(73) Assignee: CANON KABUSHIKI KAISHA, Tokyo (JP)

(21) Appl. No.: 13/372,353

(22) Filed: Feb. 13, 2012

(30) Foreign Application Priority Data
Mar. 14, 2011 (JP) 2011-055341

(51) Int. Cl. G06K 15/02

(52) U.S. Cl. 358/1.15

(57) ABSTRACT

An information processing apparatus includes a management unit, a printer information acquisition unit, a status acquisition unit, a creation unit, and a transmission unit. The management unit manages printer information of a plurality of printers. The printer information acquisition unit acquires, from the managed printer information, printer information corresponding to a login request accepted from a client terminal. The status acquisition unit acquires statuses of printers indicated by the printer information acquired by the acquisition unit. The creation unit creates, based on the printer information acquired by the printer information acquisition unit and the statuses acquired by the status acquisition unit, a screen which can discriminate printers capable of printing at the client terminal. The transmission unit transmits the screen created by the creation unit to the client terminal.

### BACKGROUND OF THE INVENTION

1. Field of the Invention

The present invention relates to an information processing apparatus, a control method for an information processing apparatus, and a storage medium.

2. Description of the Related Art

Techniques such as a cloud computing system or a Software as a Service (SaaS) have begun to be utilized. Along with this, print servers which have been running on conventional corporate Intranet environments have begun to be open to public and utilized as the Internet service. Providing a service as a cloud service results in that, management of hardware for each client becomes unnecessary by arranging the print server on a large scale data center. Further, there are such various merits as: addition of resources depending on a load of the server is easily performed.

In a printing system in which a print server and printers exist within the conventional Intranet, a push-type printing is executed to perform communication directly with the printers from the print server, and to send print data directly to the printers from the print server.

Japanese Patent Application Laid-Open No. 2008-146437 discusses a printing method, in which a print server causes printers scattered at various points within the Intranet, to perform printing. According to the method, it is determined that printing can be performed only in a case where a terminal and a printer performing the printing exist at the same point and, the push-type printing is performed.

### SUMMARY OF THE INVENTION

According to an aspect of the present invention, an information processing apparatus includes a management unit configured to manage printer information of a plurality of printers, a printer information acquisition unit configured to acquire, from the managed printer information, printer information corresponding to a login request accepted from a client terminal, a status acquisition unit configured to acquire statuses of printers indicated by the printer information acquired by the acquisition unit, a creation unit configured to create, based on the printer information acquired by the printer information acquisition unit and the statuses acquired by the status acquisition unit, a screen which can discriminate printers capable of printing at the client terminal, and a transmission unit configured to transmit the screen created by the creation unit to the client terminal.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a diagram illustrating an entire configuration of a printing system in an exemplary embodiment.

FIG. 2 is a hardware configuration diagram of a client terminal, a print server, and a printer of a printing system in the exemplary embodiment.

FIG. 3 is a system configuration diagram of the printing system in the exemplary embodiment.

FIG. 4 is a software configuration diagram of the print server of the printing system in the exemplary embodiment.

FIG. 5 is a software configuration diagram of a pull-print application, and a pseudo push-print application of the printing system in the exemplary embodiment.

FIG. 6 is an example of printer information which is managed by a printer management service of the printing system in the exemplary embodiment.

FIG. 7 is a sequence diagram of printing function check processing at the time of user login in the printing system according to the exemplary embodiment.

FIG. 8 is a detailed flow diagram of pseudo push-printing check script generation processing of the printing system in the exemplary embodiment.

FIG. 9 is an example of a list of printers available by a user of the printing system in the exemplary embodiment.

FIG. 10 is an example of a list of printers after the end of printing function check processing in the printing system according to the exemplary embodiment.

FIG. 11 is an example of a screen, which allows a user to determine printers which output print data, in the printing system according to the exemplary embodiment.

FIG. 12 is another example of a screen, which allows a user to determine printers which output print data, in the printing system according to the exemplary embodiment.

FIG. 13 is a flowchart illustrating printer selection screen generation processing in the printing system according to the exemplary embodiment.

### DESCRIPTION OF THE EMBODIMENTS

Various exemplary embodiments, features, and aspects of the invention will be described in detail below with reference to the drawings.

A print server provided on the Internet as the cloud service, may not communicate directly with the printer, and push-printing cannot be performed in some cases, due to existence of firewall.

In such cases, there is utilized a method for realizing pseudo push-printing, by a print server. In this method, the print server which has received print instruction from a client terminal controls the client terminal to issue print instruction to the printer. However, in this method, an environment in which the client terminal and the printer can directly communicate with each other is necessary, and there is a case where pseudo push-printing cannot be performed, depending on a combination of a client terminal which a user utilizes and the printer at print-destination.

Furthermore, in a case where the push-printing cannot be utilized, pull-printing function is used to select print data and perform the printing by the printer. In this method, a user interface for selecting the print data by the printer becomes necessary, and a low-priced printer which does not possess the highly functional user interface cannot utilize the pull-printing function in some cases.

As described above, it is very difficult for the user to determine a printer and a printing method which perform printing, by considering the functions of the client terminal and the printer utilized by the user.

Embodiments are directed to providing an information processing apparatus capable of offering to the user the printer and the printing method which can perform printing, in the client terminal when the user logs in to a print server from a client terminal.

Hereinbelow, exemplary embodiments for implementing the present invention will be described with reference to the drawings.

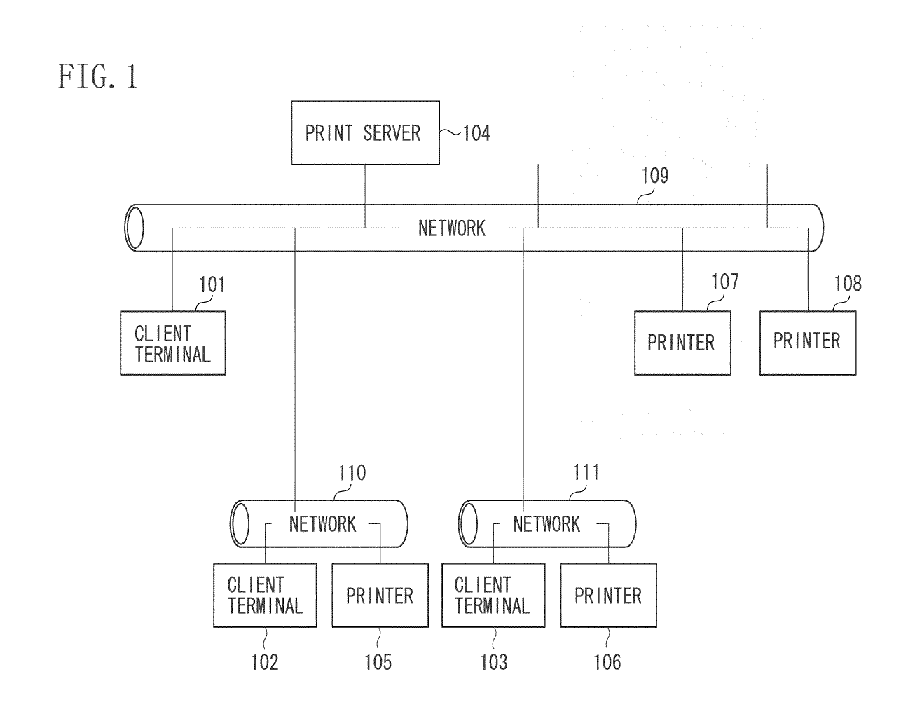

FIG. 1 is a diagram illustrating an entire configuration of a printing system according to an exemplary embodiment. In FIG. 1, client terminals 101 to 103, a print server 104, and printers 105 to 108 are connected via networks 109 to 111. In FIG. 1, it is assumed that a plurality of the client terminals 101 to 103, and the printers 105 to 108 is connected. The networks 109 to 111 are communication networks that are realized by any of, for example, a local area network (LAN), a wide area network (WAN) such as the Internet, a telephone line, a dedicated digital line, an Asynchronous Transfer Mode (ATM) or a cable television line, a data broadcasting wireless line, or combinations thereof. The networks 109 to 111 may be used as long as transmission and reception of data are possible. A communication unit from the client terminals 101 to 103 to the print server 104, and the printers 105 to 108, and a communication unit from the printers 105 to 108 to the print server 104 may be different from each other.

The client terminals 101 to 103 are information processing apparatuses that are applied to an exemplary embodiment, and include, for example, a disk top personal computer (PC), a notebook PC, a mobile PC, and a personal data assistant (PDA). Further, the client terminals 101 to 103 may be mobile phones into which execution environment of programs is incorporated. Into the client terminals 101 to 103 is incorporated an environment in which programs such as Web browsers (Internet browsers, WWW browsers, browsers made available for use in World Wide Web) are executed.

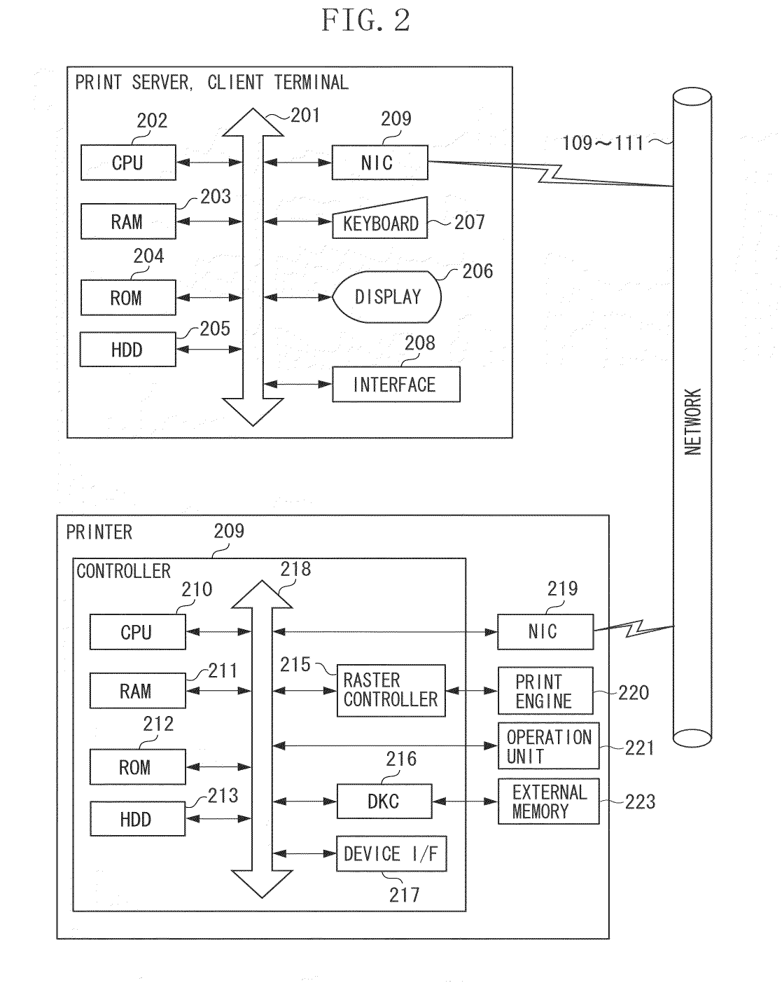

FIG. 2 is a hardware configuration diagram of the client terminals 101 to 103, and the print server 104 serving as the information processing apparatus and the printers 105 to 108 serving as the printing apparatuses of the printing system according to the exemplary embodiment.

A central processing unit (CPU) 202 performs control of the entire apparatus. The CPU 202 executes an application program, an operating system (OS) and the like stored in a hard disk (HDD) 205, and performs control to temporarily store information, files and the like necessary for execution of programs in a random access memory (RAM) 203. A read only memory (ROM) 204 is a storage unit, and stores in the inside various data including programs such as a basic I/O program, print data to be used when print processing is performed, printer information and the like. The RAM 203 is a temporary storage unit, and functions as a main memory, work area of the CPU 202.

The HDD 205 is one of external storage units, which functions as amass memory, and stores application programs such as Web browsers, print server programs, OSs, and related programs. A display 206 is a display unit, and is used to display a command, or a status of the printer input from a keyboard 207. An interface 208 is an external apparatus I/F, and connects the printers, universal serial bus (USB) devices, and peripheral devices. The keyboard 207 is an instruction input unit. A system bus 201 controls a flow of data within the apparatus. A network interface card (NIC) 209 exchanges data with external apparatuses, via the interface 208, and the networks 109 to 111. The configuration of the information processing apparatus is only an example, and it is not limited to the configuration example in FIG. 2. For example, storage destinations of data or programs can be changed to the ROM 204, the RAM 203, the HDD 205 or the like, depending on their features.

A controller 210 is a controller for the printers 105 to 108, and serves as a control system of the printers. A CPU 211 controls the entire apparatus, and collectively controls accesses to various types of devices connected to a system bus 218. This control is based on control programs stored in a ROM 213 or control programs or resource data (resource information) stored in an external memory 223 connected via a disk controller (DKC) 216. A RAM 212 functions as a main memory or work area of the CPU 211. The ROM 213 is an external storage unit that functions as a mass memory, and stores a pull-print application program or a pseudo push-print application program, and related programs.

An operation unit 221 is used for operating the printers 105 to 108, and comes in varying designs ranging from the highly functional ones equipped with a large-sized touch panel display to the ones equipped with a minimum light-emitted display (LED) lamp or only buttons, depending on performances of the printers 105 to 108. Further, a NIC 219 exchanges data with the external apparatuses via the interface 208, and the networks 109 to 111. A print engine 220 illustrated in FIG. 2 uses known printing technique, and preferable systems include, a system using, for example, an electrophotographic method (laser beam method) or an inkjet method, a sublimation method or a thermal transfer method. A raster controller 215 is a controller that converts print data represented by page description language (PDL)/portable document format (PDF) language, into image data. A device I/F 217 is a connection I/F with external devices connectable by USB.

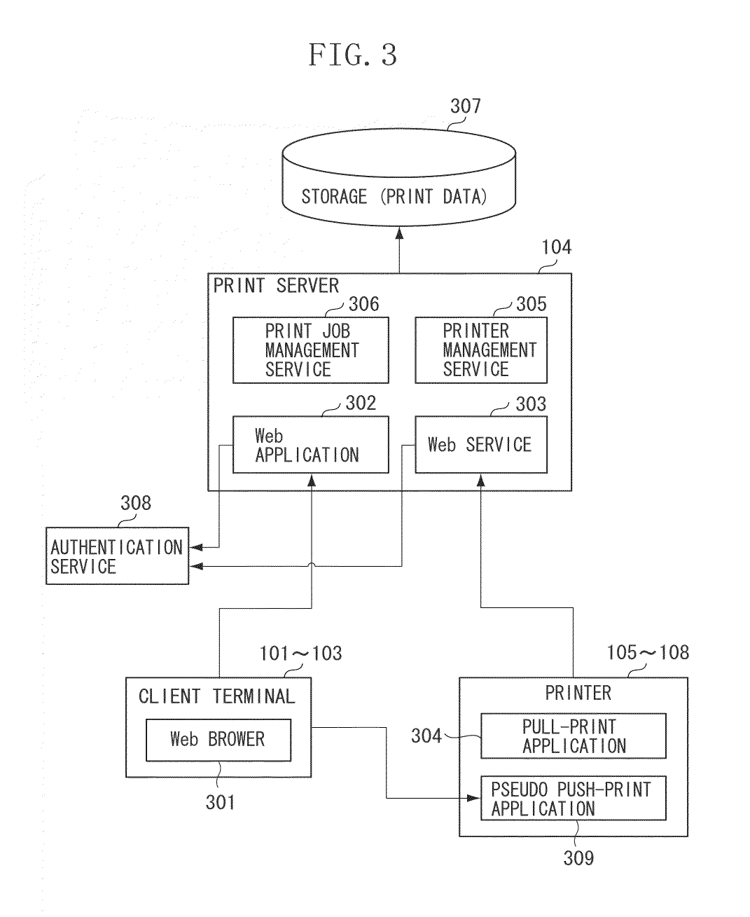

FIG. 3 is a system configuration diagram of the printing system according to the exemplary embodiment. The print server 104 includes a print job management service 306 that manages print jobs. The print job management service 306 manages document data or the like introduced from other services, or other programs in a storage 307 as print data. The data format of the print data is a format such as the PDL or the PDF. Further, the storage 307 is a HDD incorporated into the information processing apparatus of the print server 104 or, an externally connected HDD, or a storage device such as network storage.

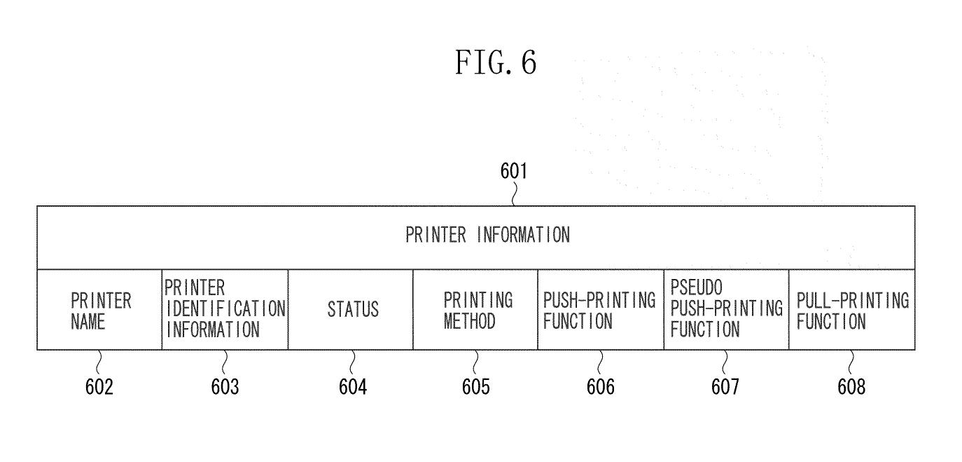

A printer management service 305 is a service that manages the printers 105 to 108, and manages printer information of the respective printers. The details of the printer information will be described below with reference to FIG. 6. A Web application 302 creates Web pages displayable by Web browser 301 that operates on the client terminals 101 to 103. The Web application 302 responds to a request from the Web browser 301, and returns the created Web pages. A Web service 303 returns a response to a request from pull-print application 304 or pseudo push-print application 309 of the printers 105 to 108. The pseudo push-print application 309 of the printer 105 to 108 receives a request from the Web browser 301.

The pull-print application 304 and the pseudo push-print application 309 are installable or uninstallable, depending on performance of the printer, and there are three cases of no applications, only either one application, and both applications.

Further, the print job management service 306, the printer management service 305, the Web application 302, and the Web service 303 are programs independent from one another, and they can be arranged in the different information processing apparatuses. These programs are arranged in the information processing apparatuses connected to respective networks, and communications are performed among the respective programs. Further, these programs can also be arranged in the same information processing apparatus.

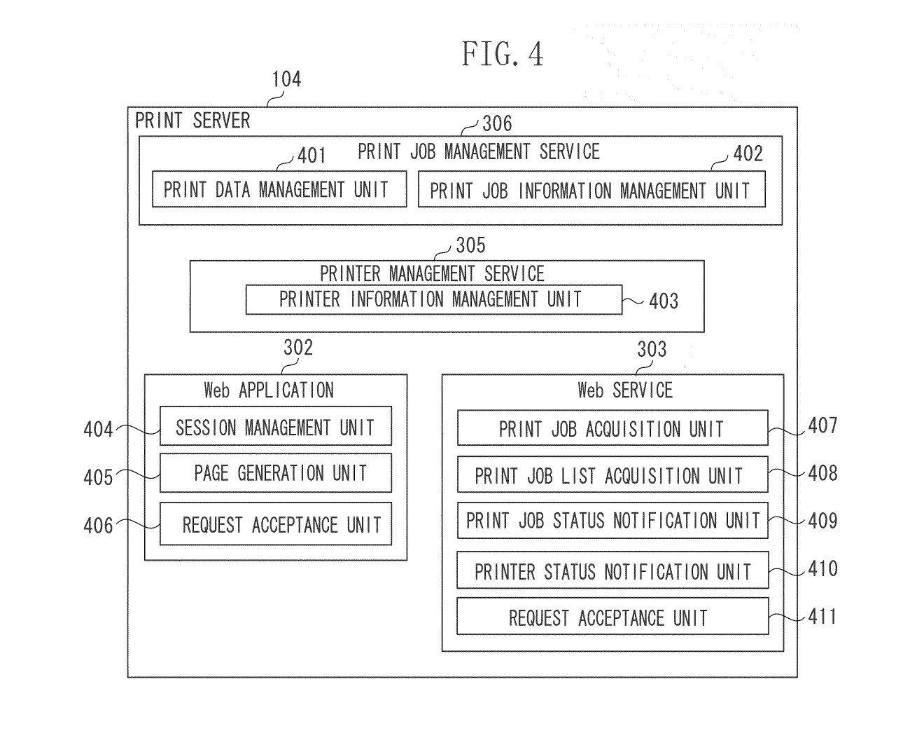

FIG. 4 is a software configuration diagram of the print server 104 of the printing system according to the exemplary embodiment. A print data management unit 401 of the print job management service 306 located in the print server 104 performs management of the print data. Upon receiving an acquisition request of the print data from the Web service 303, the print data management unit 401 acquires designated print data from the storage 307, and delivers it to the Web service 303. A print job information management unit 402 manages print job information of the print data managed by the storage 307. The job information is composed of information such as job identifications IDs for identifying print data, document names, job types for identifying data formats, print statuses, received dates and times, final printed dates and times, user names, number of pages, page sizes, link destinations of the print data. Further, among the print statuses, there are statuses such as during standby, during transfer, during printing, normal end, and error end. The printer information management unit 403 of the printer management service 305 manages the printer information in FIG. 6 described below.

A session management unit 404 of the Web application 302 manages a request from the Web browser 301 which has been authenticated by an authentication service 308 as a session. A page generation unit 405 creates a Web screen in response to the request from the Web browser 301, and returns a reply to the Web browser 301. A request acceptance unit 406 receives the request from the Web browser 301.

A request acceptance unit 411 of the Web service 303 receives a request from the pull-print application 304 or the pseudo push-print application 309. A print job acquisition unit 407, when the request acceptance unit 411 receives a print job acquisition request, issues the print data acquisition request to the above-described print job management service 306. A print job list acquisition unit 408, when the request acceptance unit 411 receives a print job list request, issues a print job list acquisition request to the above-described print job management service 306. A print job status notification unit 409, when the request acceptance unit 411 receives a print job status notification request, notifies the above-described print job management service 306 of the job status. A printer status notification unit 410, when the request acceptance unit 411 receives a printer status notification request, notifies the above-described printer management service 305 of the printer status.

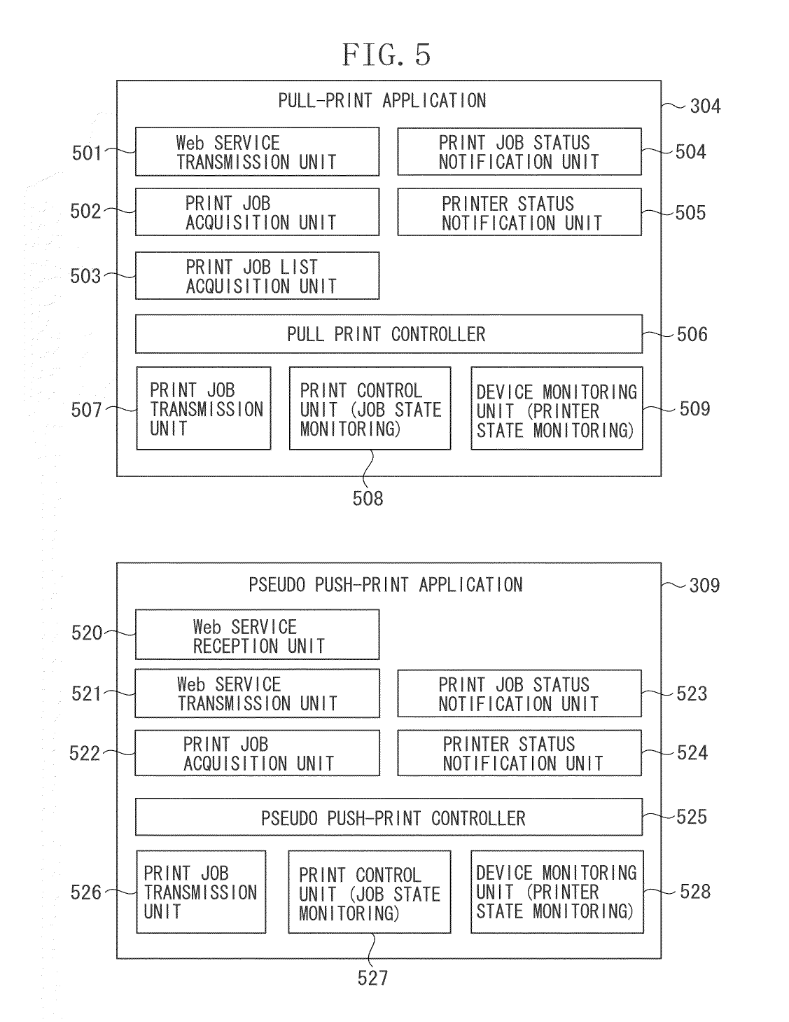

FIG. 5 is a software configuration diagram of the pull-print application 304, and the pseudo push-print application 309 of the printing system according to the exemplary embodiment. The pull-print application 304 is an application which the user operates on an operation unit 221 of the printer. The pull-print application 304 provides functions such as acquiring and printing a print job from the print server 104, based on a print job list display of the user, or print instructions from the user.

A Web service transmission unit 501 of the pull-print application 304 makes a request to the Web service 303. A print job acquisition unit 502 acquires a print job from the Web service 303, through the Web service transmission unit 501, and sends it to a print job transmission unit 507. The print job transmission unit 507 transmits print data to the controller 210. A print job list acquisition unit 503 acquires a print job list from the Web service 303 through the Web service transmission unit 501. A print job status notification unit 504 acquires a status of the print job from the controller 210 via a print control unit 508. Furthermore, the acquired job status is notified to the Web service 303 through the Web service transmission unit 501. A printer status notification unit 505 acquires a status of the printer from the controller 210 via a device monitoring unit 509. Furthermore, the acquired printer status is notified to the Web service 303 through the Web service transmission unit 501.

A pull-print controller 506 performs operation management of the pull-print application 304 as a whole, and operation instructions to respective units are performed via the controller. The pseudo push-print application 309 is an application which does not have a user interface operating on the printer. The pseudo push-print application 309 provides functions such as returning the printer status, and acquiring and printing the instructed print job from the print server 104, according to instructions from the Web browser 301.

The configuration of the pseudo push-print application 309 is nearly similar to that of the pull-print application 304. A print job acquisition unit 522, a print job status notification unit 523, and a printer status notification unit 524 have similar functions to those of the print job acquisition unit 502, the print job status notification unit 504, and the printer status notification unit 505 of the pull-print application 304. A pseudo push-print controller 525 performs operation management of the pseudo push-print application 309 as a whole and gives operation instructions to respective units via the controller. A Web service reception unit 520 receives a request from the Web browser 301. If the request from the Web browser 301 is a status acquisition request, the pseudo push-print application 309 makes response of a printer status. Further, if the request from the Web browser 301 is a print instruction request, the pseudo push-print application 309 acquires a print job from the print server 104, via the print job acquisition unit 502 and performs printing.

FIG. 6 is an example of printer information managed by the printer management service 305 of the printing system according to the exemplary embodiment. Printer information 601 includes items to be managed with respect to the printers 105 to 108 managed by the print server 104. A printer name 602 is a name of printer to be presented to the user, which is arbitrarily set by the user at the time of printer registration. Pinter identification information 603 is information to uniquely identify respective printers, which is Internet protocol (IP) address, or media access control (MAC) address or the like. The setting is also performed by the user at the time of printer registration. A status 604 is a status of the printer including, for example, the following types. That is, paper out, paper clogging, cover open, toner out, paper discharge bin full, hard disk full, other errors, during warming-up, during calibration, during initialization, off-line, during sleep, during printing, able-to-print, state unknown and so forth. Information notified by the printer status notification units 505 and 524 is held.

A printing method 605 is management information indicating a printing method which is currently available on the printer, and states of “non”, “pseudo push”, “push”, and “pull”. Update of the setting information will be described below. The push-printing function 606 memorizes whether push-printing can be performed on the printer. The setting value is determined, when printer registration is performed, by performing communication to the NIC 219 of the printer, from the printer management service of the print server 104, to check if communication can be performed to the printer. If communication can be performed, “enabled” is set, and if communication cannot be performed, “disabled” is set. A pseudo push-printing function 607 memorizes whether the printer holds pseudo push-printing function. When the pseudo push-print application 309 is activated on the printer, the printer status notification unit 524 notifies accordingly to the Web service 303 of the print server 104, through a Web service transmission unit 521, and the setting value is set accordingly. If notified, “enabled” is set, and if not notified, “disabled” is set.

A pull-printing function 608 memorizes whether the printer holds pull-printing function. When the pull-print application 304 is activated on the printer, the printer status notification unit 505 notifies the Web service 303 of the print server 104, through the Web service transmission unit 501, and the setting value is set as “enabled”. If not notified, the setting value is set as “disabled”.

The printer information 601 described herein is managed for each client terminal by the printer management service 305. Further, the printer information 601 may be managed for each user, rather than for each client terminal.

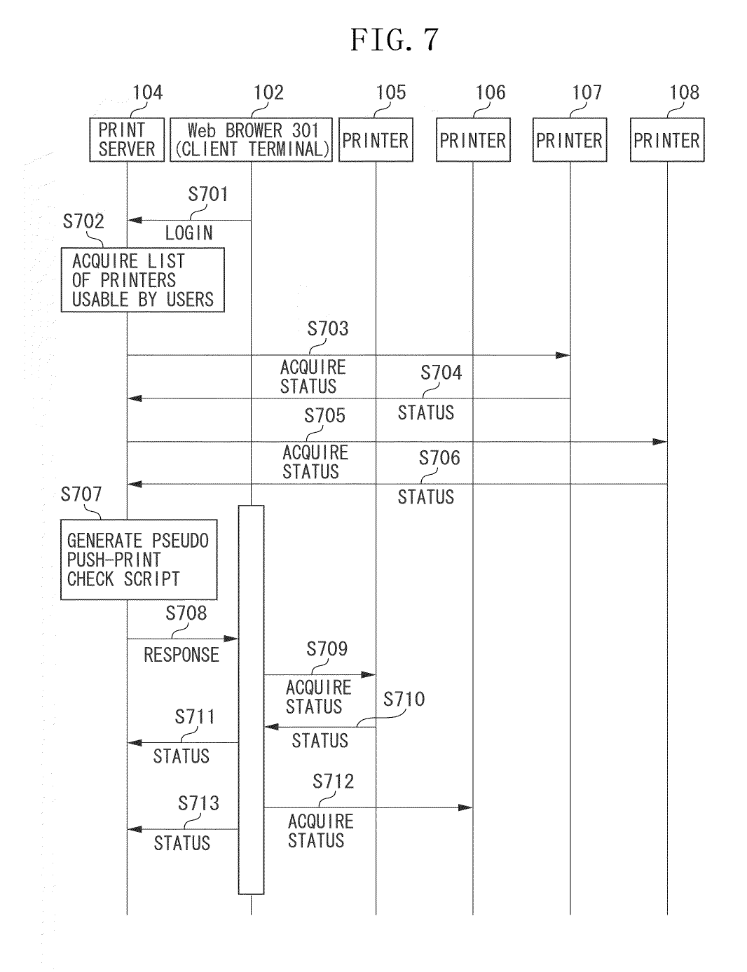

FIG. 7 is a sequence diagram of printing function check processing at the time of user login, according to the exemplary embodiment. Through the processing, a status and a printing method of a printer available among the client terminals 101 to 103 to which the user has logged in become clear.

In step S701, the Web browser 301 of the client terminals 101 to 103 makes a login request to the print server 104. In this process, the login request contains information for identifying a client terminal and a login user. FIG. 6 illustrates an example of the login performed in the client terminal 102.

The print server 104 authenticates a login user at the authentication service 308, and performs processing in step S702. Step S702 is processing of acquiring a list of printers available by the client terminal to which the login user has logged in. The Web application 302 acquires printer information (printer information acquisition processing) managed with regard to the client terminal 102 indicated by the login request, out of printer information managed by the printer information management unit 403 of the printer management service 305. In a case where printer information is managed for each user, in step S702, the printer information managed with regard to the login user will be acquired. Through the processing in step S702, printer information corresponding to the login request can be acquired from a plurality of pieces of printer information being managed.

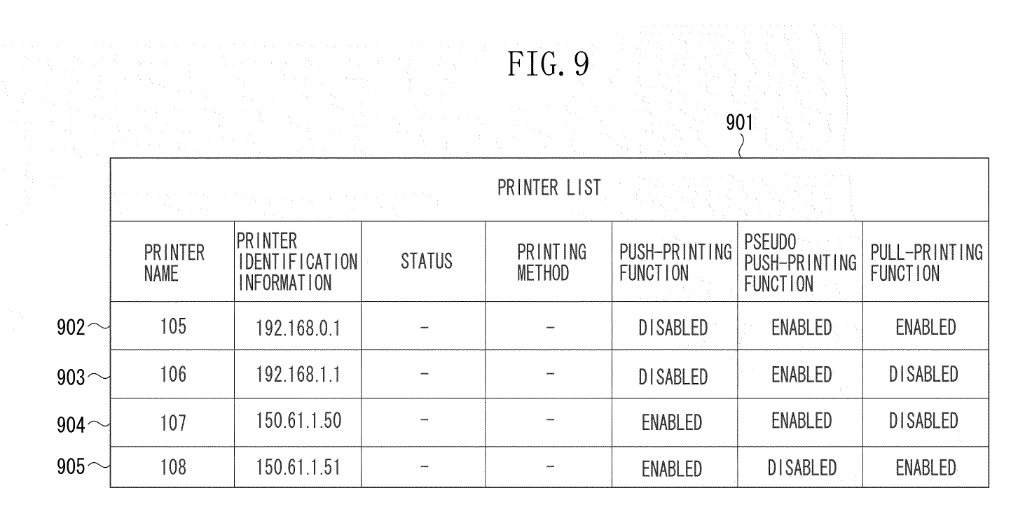

FIG. 9 is an example of a list of printers available by users. The processing will be described from here using the example as a precondition. A printer list 901 is a list of printers available in the client terminal to which the login user has logged in. A setting 902 is a setting of the printer 105, and holds the setting values relating to the printer information 601. The printer 105 executes both the pull-print application 304 and the pseudo push-print application 309, and has the functions of the both applications. Further, the printer list 901 holds an Internet protocol (IP) address such as 192.168.0.1 as printer identification information. Similarly, the settings 903 to 905 will give settings of the printers 106 to 108.

In steps S703 to S706, the Web application 302 of the print server 104 performs status acquisition on the controller 210 of the printer having the push-printing function. In the example, since the push-printing functions are set as “enabled”, in the setting 904 of the printer 107 and in the setting 905 of the printer 108, the Web application 302 of the print server 104 performs status acquisition on the controllers 210 of the printer 107 and the printer 108. In step S707, the Web application 302 of the print server 104 performs generation of the pseudo push-print check script.

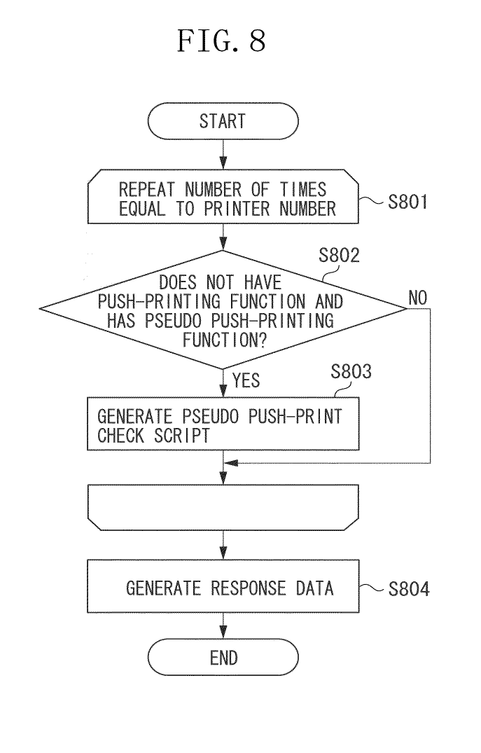

FIG. 8 illustrates a detailed flow diagram in step S707. In step S801, the Web application 302 performs repetitive processing the required number of times equal to the number of available printers managed in the printer list 901. In step S802, the Web application 302 checks whether the printer does not have the push-printing function, and has the pseudo push-printing function, from the information of the printer list 901. If the printer correspond to the check (YES in step S802), in step S803, the Web application 302 generates a pseudo push-print check script. In the present exemplary embodiment, since the push-printing function is set as “disabled”, and the pseudo push-printing function is set as “enabled”, in the setting 902 of the printer 105 and the setting 903 of the printer 106, scripts for the printer 105 and the printer 106 are generated. In the script, processing of making a request to the pseudo push-print application 309 of the printer having an IP address of the printer identification information, and notifying the print server of the result are described. (When repetitive processing in step S801 ends, in step S804, the page generation unit 405 of the Web application 302 generates response data to be returned to the Web browser 301. Into the response data are incorporated the screen of login result and the pseudo push-print check script generated in step S803.

When the processing in step S707 ends, at the print server 104, in step S708, the Web application 302 returns the response generated in step S804 to the Web browser 301. The Web browser 301 analyzes the acquired response, and executes processing of the above-described script. The Web browser 301 executes the script in step S708, and makes a status acquisition request to the Web service reception unit 520 of the pseudo push-print application 309 of the printer 105. The Web service reception unit 520 of the printer 105, which has received the status acquisition request, acquires a status from a device monitoring unit 528, then in step S710, makes a response to the Web browser 301. In step S711, the Web browser 301 notifies the print server 104 of the status received from the printer 105 as well as the pseudo push-print-enabling status. The print server 104 which has received the notification updates the status 604 of the printer information 601 managed by the printer information management unit 403.

Subsequently in step S712, the Web browser 301 makes a status acquisition request to the pseudo push-print application 309 of the printer 106. In the exemplary embodiment, since the client terminal 102 and the printer 106 are connected to different networks 110 and 111, and cannot communicate with each other, the printer 106 cannot receive a request in step S712 and cannot return a response. The Web browser 301, giving up status acquisition in step S712, in step S713, transmits pseudo push-print-disabling status to the print server 104. The print server 104 which has received notification updates the status 604 of the printer information 601 managed by the printer information management unit 403. Through the above processing, statuses and printing methods of the printers available by the client terminal 102 to which the user has logged in become clear.

By switching methods for acquiring a status of printer, according to function information of the respective printers which the acquired printer information indicates, status acquisition suitable for the function of the printer becomes possible. More specifically, the printers having the push-printing function can perform direct communication with the print server 104. For this reason, in this case, as indicated by the processing in steps S703 and S705, the print server 104 transmits requests for direct acquisition of statuses to respective printers, without intervention of the client terminal. On the other hand, for the printers which do not have the push-printing function, direct communication cannot be performed from the print server 104 to the printers. At this time, if the printer has the pseudo push-printing function, it is possible to perform communication from the client terminal to the printer. For this reason, if the printer does not have the push-printing function, and has the pseudo push-printing function, the print server 104 transmits a request for acquisition of status to the printer, via the client terminal.

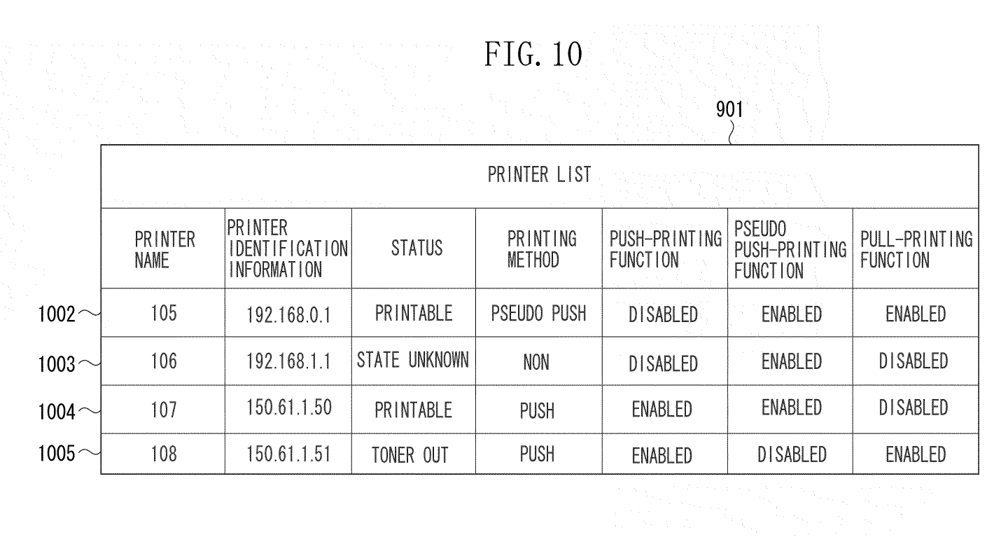

FIG. 10 illustrates a state of the printer list 901, in a state where the processing described up to FIG. 9 is ended. Status information and printing methods of the respective printer settings are updated. In setting 1002, information that the printer 105 is capable of printing by pseudo push-printing is recorded. This is because the printer 105 has pseudo push-printing function, and it has been determined that it can be utilized from the client terminal 102 currently being logged in through the processing in steps S708 to S711. In setting 1003, information that the printer 106 does not have a printing method, and a state is unknown is recorded. It is because the printer 106 only has the pseudo push-printing function, and it has been determined that pseudo push-printing cannot be utilized from the client terminal 102 currently being logged in through processing in steps S712 and S713. In setting 1004, information that the printer 107 is capable of printing by push-printing is recorded. The printer 107 has the push-printing function, and the status acquired through the processing in steps S703 and S704 is recorded. In setting 1005, information that the printer 108 is capable of push-printing and toner is out is recorded. The printer 108 has the push-printing function, and the status acquired through the processing in steps S705 and S706 is recorded. The status indicates that printing becomes enabled if an error is resolved.

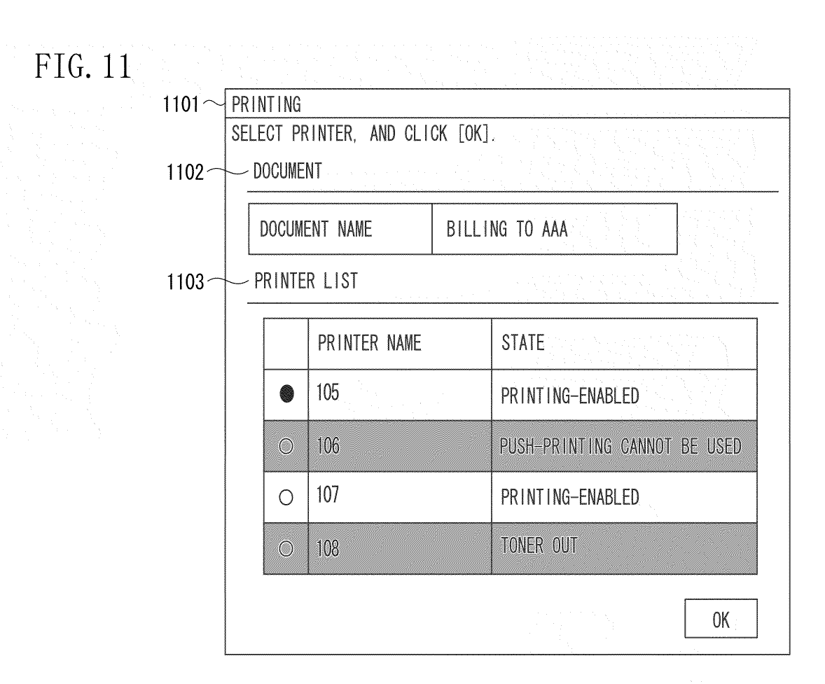

FIG. 11 illustrates an example of a screen on which the user determines which printer is to be used to output print data. The screen is created by the page generation unit 405 of the print server 104, and is displayed on the Web browser 301 of the client terminals 101 to 103. The example is based on the information in FIG. 10.

On a printer selection screen 1101, a document name of a document to be printed is displayed on a document 1102. A printer list 1103, generated based on the information in FIG. 10, is a list for selecting a printer by which the user wants to print. The printer 106 is in a state where it cannot be selected since push-printing and pseudo push-printing cannot be utilized, and the reason for that is displayed. Although the printer 108 is capable of push-printing, it is in a state where it cannot be selected since toner is out, and the reason for that is displayed. The printer 105 and the printer 106 each are configured such that pseudo push-printing and push-printing are available, and the printers are in print-enabling status, accordingly they are selectable, and print-enabling message is displayed.

By displaying a message indicating the states of the respective printers on which the information acquired from the respective printers has been reflected, the users of the client terminals 101 to 103 can recognize at a glance which printer should now be used. Further, by making printers incapable of printing unselectable, and displaying the printers capable of printing in an identifiable state, the user can avoid mistakenly making a print instruction. In the exemplary embodiment, printers capable of push-printing, and printers capable of pseudo push-printing are equally displayed as “print-enabling”. However, instead of limiting to this configuration, a method in which the printing is enabled may be displayed for each printer, according to the printer information 601.

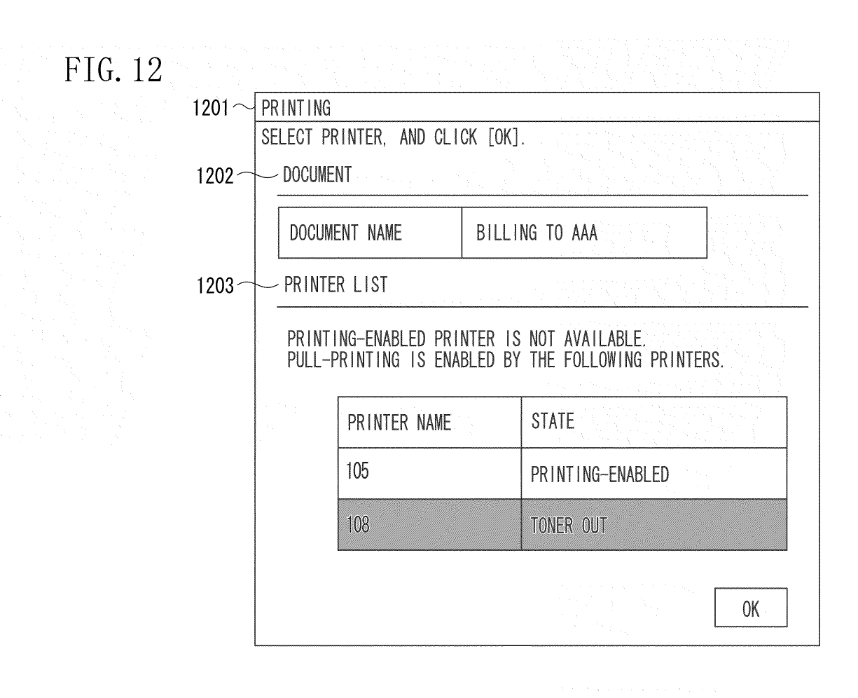

FIG. 12 illustrates another example of a screen for the user to determine which printer to be used to output print data. The screen is also created, similarly to FIG. 11, at the page generation unit 405 of the print server 104, and is displayed on the Web browser 301 of the client terminals 101 to 103. The example corresponds to a case where a printer which can carry out push-printing or pseudo push-printing is not present, and a case where printers having the pull-printing function are present in a list of printers available by the user.

On a printer selection screen 1201, a name of a document to be printed is displayed on a document 1202. In a printer list 1203, a message to inform the user that printers capable of printing are not present, and a list of printers having the pull-printing function and statuses of respective printers are displayed. This example displays that the printer 105 and the printer 108 have the pull-printing function, but toner is currently out in the printer 108.

The printer selection screens in FIG. 11 and FIG. 12 are created by the page generation unit 405, based on the printer information of the respective printers managed by the printer information management unit 403, and statuses of the respective printers acquired by the print server 104. The created printer selection screen is transmitted to the client terminal which has received a request from the print server 104, and is displayed on the Web browser 301 of the client terminal.

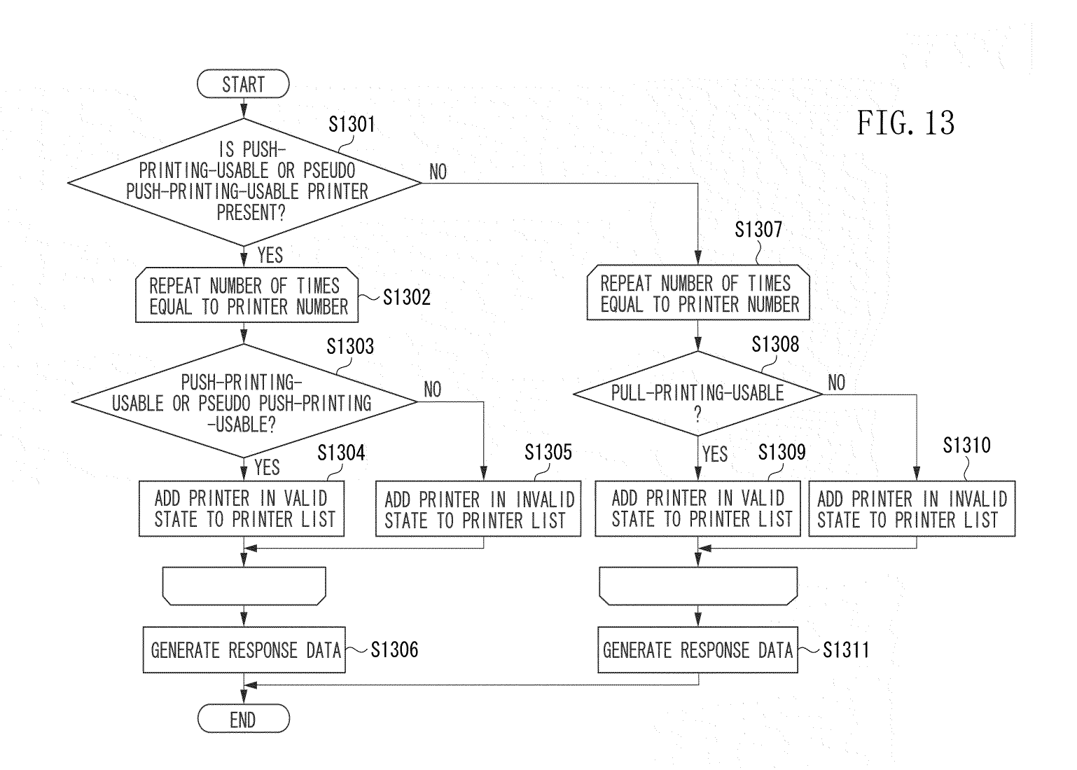

FIG. 13 illustrates a flow of generation processing of the printer selection screens 1101 and 1201 at the page generation unit 405 of the print server 104. This is the processing performed when the Web application 302 of the print server 104 receives screen acquisition request in FIG. 12 or FIG. 13 from the Web browser 301.

In step S1301, the Web application 302 checks whether a push-printing-available or pseudo push-printing-available printer is present, from the list of printers available by the user. If available printer is present (YES in step S1301), the proceeding proceeds to step S1302. If available printer is not present (NO in step S1301), the proceeding proceeds to step S1307. The processing in steps S1302 to S1306 corresponds to the processing for generating FIG. 11, and the processing in steps S1307 to S1311 corresponds to the processing for generating FIG. 12.

First, the processing in steps S1302 to S1306 will be described. In step S1302, the Web application 302 performs repetitive processing the number of times equal to the number of available printers. In step S1303, the Web application 302 checks whether the printer capable of push-printing or pseudo push-printing is available. If available (YES in step S1303), in step S1304, the page generation unit 405 adds the printer to the printer list in a valid state. The states of the printers 105 and 107 in FIG. 11 correspond thereto. If not available (NO in step S1303), in step S1305, the page generation unit 405 adds the printer to the printer list in an invalid state. The states of the printers 106 and 108 in FIG. 11 correspond thereto. In step S1306, the page generation unit 405 generates response data of the entire printer selection screen, based on the results of steps S1304 and S1305. The generated response data results in the screen in FIG. 11.

Next, the processing in steps S1307 to S1311 will be described. In step S1307, the Web application 302 performs the processing the number of times equal to the number of available printers. In step S1308, the Web application 302 checks whether the printer capable of pull-printing is available. If available (YES in step S1308), in step S1309, the page generation unit 405 adds the printer to the printer list in a valid state. The state of the printer 105 in FIG. 12 corresponds thereto. If not available (NO in step S1308), in step S1310, the page generation unit 405 adds the printer to the printer list in an invalid state. The state of the printer 108 in FIG. 12 corresponds thereto. In step S1311, the page generation unit 405 generates response data of the entire printer selection screen, based on the results of steps S1309 and S1310. The generated response data results in the screen in FIG. 12.

Hereinabove, a flow of a series of processing in the exemplary embodiment has been described. According to the exemplary embodiment, it becomes possible to determine function or state of the client terminal and printer which the user utilizes, and to present optimal printing method and printer to the user.

### Other Embodiments

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium). In an example, a computer-readable medium may store a program that causes an information processing apparatus to perform a method described herein. In another example, a central processing unit (CPU) may be configured to control at least one unit utilized in a method or apparatus described herein.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-055341 filed Mar. 14, 2011, which is hereby incorporated by reference herein in its entirety.

What is claimed is:

1. An information processing apparatus comprising:
a management unit configured to manage printer information of a plurality of printers;
a printer information acquisition unit configured to acquire, from the managed printer information, printer information corresponding to a login request accepted from a client terminal;
a status acquisition unit configured to acquire statuses of printers indicated by the printer information acquired by the acquisition unit;
a creation unit configured to create, based on the printer information acquired by the printer information acquisition unit and the statuses acquired by the status acquisition unit, a screen which can discriminate printers capable of printing at the client terminal; and
a transmission unit configured to transmit the screen created by the creation unit to the client terminal.

2. The information processing apparatus according to claim 1, wherein the status acquisition unit switches a method for acquiring a status of a printer, between a method for making a request for directly acquiring a status to a printer and a method for making a request for acquiring a status to a printer via the client terminal, according to the printer information acquired by the printer information acquisition unit.

3. The information processing apparatus according to claim 2, wherein the status acquisition unit acquires a status by a method for making a request for directly acquiring a status, to a printer capable of push-printing from the information processing apparatus, and acquires a status by a method for making a request for acquiring a status via the client terminal, to a printer incapable of push-printing, and capable of pseudo push-printing via the client terminal from the information processing apparatus.

4. The information processing apparatus according to claim 3, wherein the creation unit creates a screen which can discriminate a method by which each printer capable of printing can print.

5. A control method for an information processing apparatus, the control method comprising:
managing printer information of a plurality of printers;
acquiring, from the managed printer information, printer information corresponding to a login request accepted from a client terminal;
acquiring statuses of printers indicated by the acquired printer information;
creating, based on the acquired printer information and the acquired statuses, a screen which can discriminate printers capable of printing at the client terminal; and
transmitting the created screen to the client terminal.

6. The control method according to claim 5, wherein acquiring statuses includes switching a method for acquiring a status of a printer, between a method for making a request for directly acquiring a status to a printer and a method for making a request for acquiring a status to a printer via the client terminal, according to the acquired printer information.

7. The control method according to claim 6, wherein acquiring statuses includes acquiring a status by a method for making a request for directly acquiring a status, to a printer capable of push-printing from the information processing apparatus, and acquiring a status by a method for making a request for acquiring a status via the client terminal, to a printer incapable of push-printing, and capable of pseudo push-printing via the client terminal from the information processing apparatus.

8. The control method according to claim 7, wherein creating includes creating a screen which can discriminate a method by which each printer capable of printing can print

9. A non-transitory computer-readable medium storing a program that causes an information processing apparatus to perform the control method according to claim 5.
